(19) United States
(12) Patent Application Publication
(10) Pub. No.: US 2026/0071071 A1
(43) Pub. Date: Mar. 12, 2026

(54) OBTAINING MICROCRYSTALLINE PARAFFIN ON AN INDUSTRIAL SCALE FROM THE MIXTURE OF LIZA AND LIGHT ARABIAN OILS BY MEANS OF A CONVENTIONAL SOLVENT ROUTE

(71) Applicant: PETRÓLEO BRASILEIRO S.A. - PETROBRAS, Rio de Janeiro (BR)

(72) Inventors: ANIE DANIELA MEDEIROS LIMA, Rio de Janeiro (BR); ANTONIO CARLOS SALLARES DE MATTOS CARVALHO, Rio de Janeiro (BR); CHARLES LIMA BESSA ASSUNCAO, Rio de Janeiro (BR); ALEXANDRE DE OLIVEIRA GOMES, Rio de Janeiro (BR); RICARDO JOSE FAUSTINO DE SOUZA, Rio de Janeiro (BR); LUIS CARLOS GOMES, Rio de Janeiro (BR); EDUARDO DOMINGUEZ TRINDADE, Rio de Janeiro (BR)

(73) Assignee: PETRÓLEO BRASILEIRO S.A. - PETROBRAS, Rio de Janeiro, RJ (BR)

(21) Appl. No.: 19/317,717

(22) Filed: Sep. 3, 2025

(30) Foreign Application Priority Data
Sep. 10, 2024 (BR) 1020240186516

(51) Int. Cl. C08L 91/00

(52) U.S. Cl. CPC C08L 91/00

(57) ABSTRACT

The present invention relates to the process of obtaining microcrystalline paraffin on an industrial scale by using a load comprising a mixture of such oil, with a higher paraffinic and aromatic content, high sulfur content and originating from the Middle East, with up to 35% by mass of more naphthenic oils, produced in the Stabroek block in Guyana by means of a conventional solvent route, without the use of the adsorption process.

### CROSS-REFERENCE FOR RELATED APPLICATIONS

This application claims priority to Brazilian Application No. BR 1020240186516, filed on Sep. 10, 2024, the disclosure of which is herein incorporated by reference in the entirety.

### FIELD OF THE INVENTION

The present invention relates to a process for obtaining microcrystalline paraffin on an industrial scale from a mixture of oils with a higher paraffinic and aromatic content (Light Arabic) with oils with a higher naphthenic content and lower aromatic content (Liza and Unity Gold) by means of a Conventional Solvent Route, without the use of the adsorption process.

This invention applies to the industrial plants using a solvent route for obtaining base oils and paraffins by means of solvent extraction processes, without the use of chemical reactions, and with mild final hydrofinishing of the products.

### BACKGROUNDS OF THE INVENTION

Oil is made up of a mixture of solid, liquid and gaseous compounds formed predominantly by hydrocarbons, which correspond to around 90% of the composition of the oil, with the remaining 10% being made up of nitrogenous, oxygenated and sulphuric organic derivatives, metals, acid salts and other contaminants. It is worth highlighting that oil is a mixture of light and heavy hydrocarbons, and may contain paraffins, aromatic, naphthenic compounds, asphaltenes and resins.

The paraffins are derived from oil and are made up predominantly of linear or slightly branched chain paraffinic hydrocarbons containing 18 or more carbon atoms, and are solid at room temperature. They can be obtained as a by-product of the manufacture of paraffinic base oils, in the solvent dewaxing step of a conventional route.

The term paraffin is derived from the Latin parum affinis, which means little related. It is considered a solid, white, translucent material, derived from the distillation of oil tar or wood tar, consisting of a mixture of saturated and unsaturated hydrocarbons. The word wax is very commonly used to designate paraffin. In general, this term reflects a physical state of the matter.

The natural waxes are rare, expensive and are subdivided into animal, vegetable and mineral waxes. Animal waxes can come from bees, wool (lanolin) and whale spermaceti. Vegetable waxes are widely used in applications that require food grade characteristics and the examples include carnauba, candellila, soy, palm and coconut waxes. Mineral waxes are subdivided into ozokerite, lignite and peat waxes. These differences are based partly on chemical composition and partly on manufacturing processes.

The low molecular weight paraffins can be found in natural gas, while medium or high molecular weight paraffins are found in oil. Their production is associated with the production of paraffinic lubricating base oils. To improve the flow characteristics at low temperatures, the oils undergo a step called dewaxing, the byproduct of which is oily paraffin. These products can also be synthesized from polymerizations and Fischer-Tropsch reactions.

The oil paraffins are used in a wide variety of commercial products and applications, such as candles, plywood, cosmetics, drawing crayons, polishes, adhesives, lubricants, paper, telephone cables, electrical power cables, flexible materials, textile materials, anti-corrosive compounds, waxes, food and packaging, which will be presented later.

The paraffins can be classified as macrocrystalline, microcrystalline, soft and petrolatum, in which the microcrystalline paraffins come from the processing of the residual cuts of lubricating base oils (Bright Stock) and have a greater quantity of crystals in the form of needles, and a high content of isoalkane hydrocarbons in the range of C40 to C55. The average molecular weight of the microcrystalline paraffins varies between 580 and 800 g/gmol and the melting point between 6° and 95° C. Although the microcrystalline paraffins contain small crystals, the majority of the material is amorphous. They have an opaque appearance with a variable color, depending on the degree of refining applied.

In general, the degree of refining of a paraffin is associated with the oil content, since aromatic, nitrogenous and sulfurous contaminants tend to remain in greater concentration in the oil due to their polarity. Higher oil contents imply a higher contaminant content, higher melting point and greater penetration (lower hardness), resulting in unsuitable quality. In general, the food grade microcrystalline paraffins must have oil contents of up to a maximum of 2%.

The microcrystalline paraffin can usually be obtained industrially by means of the solvent and GTL (gas-to-liquid) routes. It has a smaller crystalline structure than other macro-type paraffins, produced from distillates, making it more viscous and flexible. Its properties may vary slightly depending on the degree of refining. It has a wide range of applications and is used in different industries, including:

Health and hygiene products, such as, for example, ointments, lotions, moisturizers, sunscreens: the material helps to give the product the right viscosity and a soft touch.

Cosmetic products: the paraffin creates a water-repellent film and is used as a binder in compact powders, in addition to giving structure to lipsticks, eyeliners and lip liners, preventing the product from crumbling.

Grease thickener: can be used in a wide variety of greases and gel products as a thickener or to make the product more resistant.

Sports equipment: is used in skis and snowboards to reduce friction and help them glide more easily on snow. It is also commonly used in hockey to protect parts of the stick and give players better control of the puck.

Additive for other waxes: can be added to other paraffin compositions to improve texture, flexibility, water resistance and other properties.

Adhesives: due to its sticky property, it is used as an adhesive, some industrial examples being bookbinding and carpet lining.

When produced via the solvent route, it derives from fractions of the oil vacuum residue, and the steps employed in the process are the separation of the oil from the solvent; adsorption, to remove the heaviest contaminants and high-severity hydrotreatment. The load of this route is usually an oil with a balanced content between paraffins, naphthenes and aromatics, aiming at the specification of the main product of the route, which is the lubricating base oil. The highest concentration of one of these compounds is what determines whether a base oil is of paraffinic or naphthenic origin.

### Conventional Solvent Route

The paraffins are produced by this route from base oils following the steps below. It is currently the most widely used industrial route for obtaining oil paraffins. A diagram of this route is shown in FIG. 1.

### Atmospheric Distillation and Vacuum Distillation

The process begins with atmospheric distillation of the oil, which produces LPG (liquefied petroleum gas), naphtha, kerosene, diesel and an atmospheric residue. The latter serves as a load for a second vacuum tower, from which the spindle, light neutral, medium neutral, heavy neutral and vacuum residue fractions can be extracted. The main role of the distillation unit is to produce the vacuum distilled cuts with defined viscosities and flash points so that, at the end of the processing, base oils are obtained with properties specified according to the market needs, mainly in relation to the viscosity index and pour point. The color is also controlled, mainly of the heavier cuts, which are the most subject to contamination in the vacuum tower due to asphaltene carryover. The asphaltenes are detrimental to the performance of subsequent units.

### Propane Deasphalting

The vacuum residue (bottom of the vacuum distillation tower) still contains lubricating fractions, which are separated by the propane extraction process. This extraction will produce the residual oil (ODES-deasphalted oil), from which the microcrystalline paraffins will be extracted.

### Dearomatization

From this step onwards, the process is carried out in batches of distilled or deasphalted oils, in which the vacuum distillate or deasphalted cuts are mixed with an appropriate solvent (Furfural, NMP (N-methyl-pyrrolidone) or phenol), which solubilizes the aromatic compounds, especially those with more than one ring, which are undesirable in the lubricating base oil because they have a low viscosity index and are unstable to oxidation. At the same time, there is a reduction in the contents of nitrogen compounds (which also interfere with the oxidation stability of the lubricating oils), sulfur compounds and oxygen compounds. When the dearomatization load is the deasphalted oil, the main product will be the raffinate Bright Stock.

### Dewaxing

The next step is the dewaxing of the raffinate oils from the previous step. The load is initially diluted in MIBK (Methyl Isobutyl Ketone) or MEK-TO (Ketone plus Toluene), so that a mixture of solvent-soluble oil with paraffin crystals in suspension is formed and, subsequently, it is cooled in special heat exchangers, in order to crystallize the paraffin fractions with a high pour point. The paraffins are separated by filtration in rotary filters.

In the dewaxing process, depending on the temperatures used in freezing, the dewaxed oil is separated from the oily paraffins. The dewaxed oil will be subjected to a hydrofinishing process and will constitute a lubricating base oil to be used in finished lubricating oil formulations. The oily paraffin will then be subjected to another treatment step.

### Deoiling

The deoiling process consists of cooling the oily paraffin to a given temperature, always higher than that used in the dewaxing, so that only the hard paraffin solidifies and can be separated from the soft paraffin by filtration.

The soft paraffin separated in the deoiling of oily paraffin is called “foot oil” (CONCAWE). Except for its high pour and melting points, due to the presence of unseparated paraffin, the properties of the “foot oil” are comparable to those of the intermediate stream oil from which the paraffin is derived.

### Adsorption of Impurities

When the hard paraffin comes from the vacuum residue, the percolation of the paraffins through clays is also used to absorb impurities to decolorize and deodorize the paraffins, and this process becomes essential for the specification of the microcrystalline paraffins as “food grade”.

### Paraffin Hydrofinishing

Finally, the hydrofinishing of paraffins aims at improving the color of products through the hydrogenation of aromatic, sulfur and oxygenated compounds. The degree of severity of the process can determine the removal of the polyaromatic substances (carcinogenic), making the product suitable for use in the food and cosmetic industries.

It is worth highlighting that, in the case of production of microcrystalline paraffins by routes involving hydrorefining processes, in which there is transformation of molecules by means of chemical reaction, the flexibility of loads is high, and any mixture can be used. In mixed routes, hydrorefining processes plus physical separation processes can be used, which provides greater flexibility in terms of the possibility of loads to be used, because there is a process with severity, thus transforming the undesirable molecules into desirable ones. In the case of the conventional, non-mixed route, in which the processes are only physical separation, the raw material is restricted and must have characteristics that, when passing through the process steps, allow the obtaining of specified products. When using a naphthenic load in hydrorefining processes under specific conditions, involving chemical reaction, the rings open and the structures transform into paraffins. This does not occur in the solvent route, and, therefore, it is not usual to use these loads to obtain paraffins and paraffinic lubricating base oils. Therefore, in the case of conventional routes, this flexibility is restricted, because there are no high-severity chemical transformation processes.

Before the present invention, the basic raw material for obtaining microcrystalline paraffin via the Solvent Route was paraffinic oils originating from the Middle East or with a very high paraffin content, originating from China or Bahia (Bahian oil). However, the flexibility of the load for this route is restricted given the fact that the main product is usually the lubricating base oil that is separated from the paraffins, which are a byproduct. In addition, since the main steps of the process are only physical separation by solvent extraction, without the involvement of chemical reactions, an adequate composition of the source oil becomes necessary. When it comes to these oils, the most important characteristics are the viscosity index and the pour point.

The viscosity index reflects the variation in the viscosity with the working temperature of the lubricant and the higher its value, the smaller this variation. As a machine operates, there is a tendency for the temperature to rise, which causes the lubricant viscosity to drop, contributing to a reduction in the lubricating film. The following compounds contribute to this index raising in increasing order: aromatic, naphthenic, isoparaffinic and paraffinic compounds.

The pour point corresponds to the lowest temperature at which the oil still flows, and is important when starting an engine, especially in cold climates. In this case, the lower the pour point, the better for the oil, because, at low temperatures, it will still be able to flow and reach the gear when the machine starts. The pour point increases with the presence of these compounds in increasing order: aromatic<naphthenic<isoparaffinic<paraffinic compounds.

It can be seen, then, that the composition must be balanced, since the presence of paraffins can contribute not only to the increase in the viscosity index, but also to the increase in the pour point, and the latter is not desirable.

In the solvent route, which involves only physical separation processes, it is essential that the distillate or deasphalted oil has some starting characteristics, since the severity of the processes may not be sufficient for the specification, restricting the loads to be used somewhat.

This route encompasses the processing of vacuum distillates and deasphalted oil in solvent dearomatization processes (to remove low viscosity index aromatics), solvent dewaxing (to remove high pour point n-paraffins from the oil), solvent deoiling (to remove excess oil from the paraffin) and hydrofinishing of the products.

The paraffins in question are obtained in the dewaxing process and are then refined in the deoiling and hydrofinishing processes.

It is important to remember that the extraction process (dearomatization) does not remove naphthenic compounds, only aromatic compounds. Therefore, in an oil with a low starting viscosity index, it is important that the quantity of aromatic compounds is sufficient to allow the viscosity index to increase after the extraction. If the distillate has a high paraffinic and naphthenic content and a lower starting viscosity index, due to the presence of naphthenics and aromatics, but does not have a high concentration of aromatics, which allows the increase in the viscosity index required for the oil specification according to standards after the dearomatization, it is very likely that it is not suitable for this route. This is because the severity used in the dearomatization must be high, causing a drop in the yield of dearomatized oil and greater production of aromatic extract and, despite this, there is not always a guarantee that the dearomatized and dewaxed oil will reach the specification limit.

As can be noted, the raw material for the solvent route is very specific and finding new alternatives that allow obtaining specified products has high value in the field of science and in the market.

### STATE OF THE ART

The paper titled “Rheological Properties and Composition of Some Vacuum Distillates Derived from Indian Crudes” (Nautiyal et al., 2008) proposes to study the effect of changing the solvent matrix on the rheological characteristics of an oil, and it demonstrated the role of n-paraffinic compounds in the variation of the pour point and viscosity in paraffinic distillate fractions as described in the Abstract: “The effect of changing the solvent matrix on the rheological characteristics was also determined. The study demonstrated the role of solid n-paraffins for the variation in the pour point and in the temperature behavior of the viscosity of waxy distillate fractions.” In this case, the authors are dealing with paraffinic base oils in the distillation range of 400-530° C. and evaluating the influence of n-paraffinic compounds on the properties of the base oil. They add paraffinic and aromatic compounds and evaluate properties related to the flow of the oil.

The present invention is not related to the oil product, but rather to the paraffin product. The two products are separated by means of a process called solvent dewaxing, precisely so that the oil flows after the removal of the paraffins, and so that the separated paraffin does not have excess oil and can be used in various applications (cosmetics, candles, fuels, waterproofing, etc.). The paraffin further undergoes a deoiling process to remove excess oil. It is a solid, white product with an oil content of up to 2%. In general, it is obtained by processing paraffinic oils in a route called solvent route (dearomatization, dewaxing, deoiling and hydrofinishing). There are several grades of this product (paraffin) and this depends on the distillation range of the oil processed in the solvent route. In the present invention, the treated grade comes from the distillation range of the vacuum residue (550° C.+), and results in a paraffin called microcrystalline with very high added value.

As can be seen, the state of the art does not present the solution proposed in the present invention by adopting a process for obtaining microcrystalline paraffin on an industrial scale from the mixture of Liza and Unity Gold oils with Light Arabic by means of a conventional solvent route.

The innovation lies in the fact that all refineries that produce this paraffin do so using paraffinic oils (Light Arabic, Bahian, Kuwait, Basrah, etc.), but the microcrystalline paraffin of the present invention was obtained by means of a mixture between a paraffinic oil and a naphthenic oil with fewer contaminants (never used for this purpose), by using the composition balance between naphthenic, aromatic and paraffinic compounds in the solvent route load. This load balance in a specific composition for obtaining a microcrystalline paraffin has never been tried. In other words, the present invention was successful in verifying the appropriate percentage of the most naphthenic oil with fewer contaminants, so that it was possible to obtain this paraffin, with the final characteristics suitable for the market.

The Liza and Unity Gold oils, produced in the Stabroek block, in Guyana, present in their vacuum cuts intended for the production of lubricating base oils, a higher content of low viscosity index naphthenic compounds compared to the Light Arabian oil, as shown in Table 1.

TABLE 1
Cut Viscosity Index 343-1000° C. derived
from the Light Arabian, Liza and Unity Gold oils.

| | Cut 343-1000° C. | | | |
|---|---|---|---|---|
| | Light | | Unity | |
| Oil | Arabian | Liza | Gold | Method |
| Viscosity at 37.8° C. | 630.1 | 913.4 | 392.6 | ASTM D445 |
| Viscosity at 98.9° C. | 28.16 | 31.67 | 20.63 | ASTM D445 |
| Viscosity Index | 65 | 46 | 59 | ASTM D2270 |
| % Naphthenic Carbon | 10.1 | 18.1 | 13.4 | ASTM 3238 |

These naphthenic compounds are not removed in the dearomatization process. Normally, they would not be indicated for obtaining lubricating base oils and paraffins; however, the inventors of the present invention attested to the possibility of producing microcrystalline paraffins from a mixture of up to 35% by mass involving these more naphthenic oils and the Light Arabian oil, thus expanding the basket of available oils.

This invention is also new and inventive, since the oils from the Stabroek block are of recent production and were not intended for the production plants of lubricating base oils and paraffins, but rather for the production of fuels.

### SUMMARY OF THE INVENTION

The present invention expands the range of possible oils for the production of microcrystalline paraffin via the solvent route by using up to 35% by mass of oils from the Stabroek block, more precisely, Liza and Unity Gold in a mixture with Light Arabian oil, which is the most used for this purpose. It should also be highlighted that such oils have more naphthenic characteristics than usual for this type of production and in theory, would not be used.

In addition, this production occurred without the need for a process of adsorption of contaminants originating from the precursor, vacuum residue, due to the characteristics of the residues of these oils, mainly with regard to the content of asphaltene compounds that impair the stability of these products and the deactivation of hydrotreatment processes.

### BRIEF DESCRIPTION OF THE FIGURES

The present invention will be described below, with reference to the attached FIGS. 1 to 3 that, in a schematic manner and not limiting the inventive scope, represent examples of its embodiment.

FIG. 1 represents a paraffin production scheme by conventional solvent route.

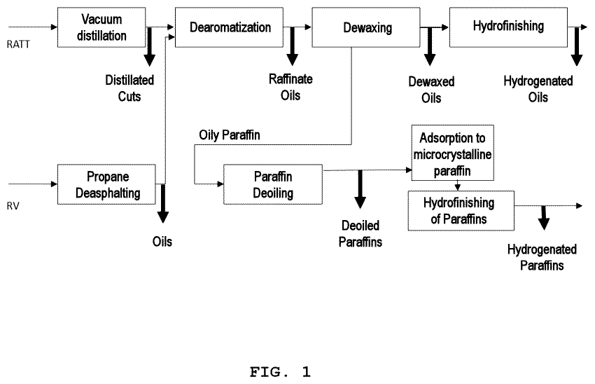

FIG. 2 represents a scheme of the Dewaxing Pilot Unit (called DP-33).

FIG. 3 illustrates the graph of asphaltene content for Unity Gold, Liza, Light Arabic (ARAL20220425) oils and for the Light Arabic+Liza mixture (35% by mass) in the Vacuum Residue.

### DETAILED DESCRIPTION OF THE INVENTION

The present invention relates to the process of obtaining microcrystalline paraffin on an industrial scale from the mixture of Liza or Unity Gold and Light Arabic oils by means of a conventional solvent route, from the use of a load encompassing a mixture between such oil, with higher paraffinic and aromatic content, high sulfur content and originating from the Middle East, with up to 35% of more naphthenic oils with low aromatic content, produced in the Stabroek block in Guyana, without the use of the adsorption process step. This adsorption process is necessary to remove contaminants from the vacuum residue, a precursor derivative of the microcrystalline paraffin, especially asphaltenes, which impair the product stability and deactivate hydrotreatment catalysts. However, the lower content of contaminant compounds present in the vacuum residue of Stabroek oils allowed this step to be dispensed with in the production scheme, which is used in all the refineries that produce this grade of microcrystalline paraffins by using paraffinic oils.

The production of the present invention begins with the atmospheric distillation processing of a mixture of Light Arabian oil with up to 35% by mass of Unity Gold or Liza oils, obtained in the Stabroek block, in Guyana. The Light Arabian oil, among others from the Middle East, is the most widely used for the production of lubricating base oils and paraffins in solvent route plants.

The atmospheric residue, with an initial boiling temperature of 370° C., is separated from the gases and fuels in the atmospheric distillation and sent to the vacuum distillation. In this process, distilled cuts of the ultralight, light, medium, heavy types and the vacuum residue are obtained. Each distillate obtained is processed in the solvent route giving rise to a base oil and a grade of paraffin.

The vacuum residue, with an initial boiling temperature of 550° C., is sent to a deasphalting process, giving rise to the asphalt residue, used in the production of asphalts and to the deasphalted oil. The deasphalted oil is processed in the solvent route and can give rise to a base oil, called Bright Stock and to the microcrystalline paraffin.

In general, since the main processes of this route are only physical separation and do not involve chemical transformation, the oil must already have characteristics that fit the final products according to their specifications, and the Taylor-made raw material is Middle Eastern oil, especially Light Arabian, with a high paraffin content and a high aromatic content. In general, oils with low aromatic content and high naphthenic content are not used.

To estimate the appropriate mixture between the aforementioned oils to obtain lubricating base oils specified in accordance with the RANP 911/2022 standard and paraffins, the software SICOL—Cognitive System for Optimization of Lubricating Base Oils was used, whose methodology was requested in BR 10 2023 0224735 0.

In this invention, mixtures of Light Arabian oil and more naphthenic and less aromatic oils from the Stabroek block, Liza and Unity Gold, were used, up to 35% by mass, and specified products were obtained. In particular, a microcrystalline paraffin, with high added value and with super refined paraffin characteristics, with oil content of less than 1% by mass, and low penetrations, in addition to food grade certification (FDA 172.886), being applicable to the formulations with food and cosmetics. The use of these oils, in addition to being an innovation for the production of this paraffin, further allowed the elimination of a step normally used in this production, an adsorption of contaminants originating from its precursor load, the vacuum residue. Such compounds impair the stability of the product and deactivate catalysts in treatment processes. This is due to the characteristics of the tested oils, which have a lower contaminant content in the vacuum residue fraction.

Therefore, the present invention relates to the process of obtaining microcrystalline paraffin by means of a conventional solvent route comprising the processing in atmospheric distillation of a mixture of Light Arabic oil, with a high paraffin content and high aromatic content, and up to 35% by mass of the Liza and Unity Gold oils, with a high naphthenic content and low aromatic content;
in which the atmospheric residue, with an initial boiling temperature of 370° C., is separated from the gases and fuels in the atmospheric distillation and sent to the vacuum distillation;
in which the vacuum residue with an initial boiling temperature of 550° C. is sent to the deasphalting step; and
in which the deasphalted oil is processed in the solvent route, generating the microcrystalline paraffin.

### Example of Embodiment/Tests and Results

The vacuum residue obtained from the processing of a mixture of Light Arabian oil and 35% by mass of oil from the Stabroek block, with a higher naphthenic content, was processed in deasphalting in an industrial unit. The deasphalted oil was processed in the dearomatization using industrial solvent, giving rise to the Bright Stock raffinate. This raffinate was then dewaxed using solvent, allowing the oily paraffin to be obtained, which was taken to the laboratory.

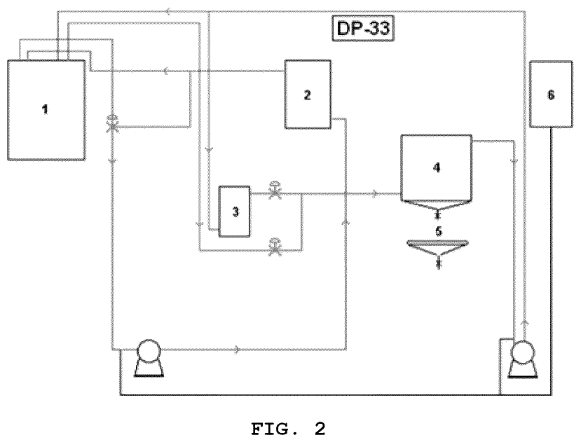

To simulate the industrial deoiling unit, the DP-33 Pilot Dewaxing Unit was used (FIG. 2). This unit consists of a cooling vessel (1), solvent vessel (2), heating vessel (3), crystallizer (4), filtration funnel (5) and expansion vessel (6) and is also equipped with automatic temperature control. It is possible to observe that the load preparation system, which involves heating and gradual cooling by means of the flow of the paraffin and solvent mixture in heat exchangers, occurs in a pilot plant in a vessel, where a heating/cooling curve is controlled. In this case, the flow of the mixture is not evaluated, but rather the controlled crystallization and the filtration.

Table 2 below shows the characteristics of the load (oily paraffin from Bright Stock), the operational conditions and the results for the microcrystalline paraffin.

TABLE 2
Load data, process conditions and
deoiling product data in pilot unit

| | Bright Stock Oily | |
|---|---|---|
| Paraffin Analysis | Paraffin | Method |
| Density at 90/4° C. | 0.8000-0.8500 | ASTM D4052 |
| Refractive Index at 90° C. | 1.4600-1.4700 | ASTM D1218 |
| Oil content (% m) | 10-20 | ASTM D721 |
| Operating conditions | Deoiling | |
| Temperature (° C.) | 10-16 | — |
| Solvent to oil ratio (m/m) | 10-15 | — |
| Washing ratio (m/m) | 0-4 | — |
| Paraffin yield (% m) | 30-70 | — |
| Microcrystalline Paraffin | | |
| Density at 90° C. | 0.8000-0.8500 | ASTM D4052 |
| Refractive Index at 90° C. | 1.4400-1.4500 | ASTM D1218 |
| Oil content (% m) | 0-2 | ASTM D721 |
| Viscosity at 100° (cSt) | 15-20 | ASTM D445 |
| Penetration (0.1 mm) | 10-15 | ASTM D1321 |
| Sulfur Content (% m) | <0.5 | ASTM D5762 |
| Total Aromatics (mmol/100 g) | 0-20 | IFP |

From the point of view of the deoiling process, the conditions tested in the laboratory would be viable for industrial operation, but it would be necessary to test the logistics of tanks and stream transfers in a refinery.

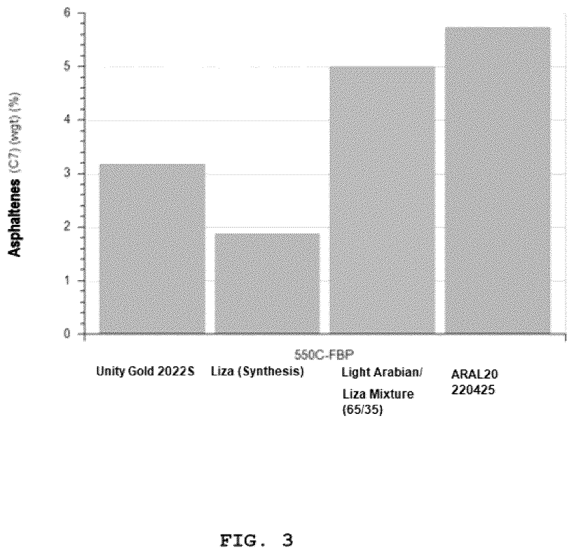

After the laboratory scale steps, an industrial test was carried out to produce microcrystalline paraffin, including hydrofinishing at the end of the deoiling. In units producing microcrystalline paraffin using the conventional solvent route, an adsorption process is generally used to remove contaminants from the vacuum residue, mainly asphaltenic compounds, which impair the stability of the product and are poisons for hydrofinishing catalysts. However, in the scheme of this invention, the paraffin was produced without the need for this process, due to the initial conditions of the aforementioned oils, which have a lower asphaltene content. FIG. 3 illustrates a bar graph referring to the asphaltene content for the Unity Gold, Liza, Light Arabian (ARAL20220425) oils and for the Light Arabian+Liza mixture (35% by mass) in the Vacuum Residue, showing the difference observed.

The result of the evaluation of the final product is shown in Table 3, together with typical specification data for this product.

TABLE 3
Hydrogenated microcrystalline paraffin in industrial test

| | Microcrystalline | Microcrystalline | |
|---|---|---|---|
| Analyses | Industrial Test | SASOL 1800 * | Method |
| Saybolt Color | 10-15 | White | ASTM |
| | | | D156 |
| Density 90/4° C. | 0.7989 | — | ASTM |
| | | | D4052 |
| Flash Point, ° C. | 300-310 | — | ASTM |
| | | | D82 |
| Oil Content, % m/m | <1 | 0-2 | ASTM |
| | | | D721 |
| Melting Point, ° C. | 70-80 | 70-80 | ASTM |
| | | | D4419 |
| Kinematic Viscosity at | 13-17 | 13-17 | ASTM |
| 100° C., cSt | | | D445 |
| Penetration at 25° C., | 10-17 | 18-22 | ASTM |
| 0.1 mm | | | D1321 |
| Refractive Index | 1.4400-1.4500 | — | ASTM |
| at 90° C. | | | D1218 |
| Total Aromatics by UV, | 8-10 | — | IFP |
| mmol/100 g | | | |
| Sulfur Content, % m/m | <0.02 | — | ASTM |
| | | | D5762 |

Data source: Available at http://biobiznes.net/pliki/prezentacje_firm/overlack/Microc rystallineWax_en.pdf

In addition to meeting the “food grade” characteristic for having a low content of polycyclic aromatic hydrocarbons, as specified by FDA 21CFR172.886 (US Food and Drug Administration), Table 3 shows that the product has similar or superior characteristics (such as the lower oil content) to microcrystalline paraffins marketed by other players.

In summary, the invention offers flexibility in the basket of oils available for Lubricant plants that operate via the conventional solvent route, obtaining a microcrystalline paraffin (Value of up to US$2500/t) instead of a gas oil that would be processed in the FCC (Fluidized Catalytic Cracking), increasing the portfolio of high value-added products and increasing competitiveness.

1. A process for obtaining microcrystalline paraffin by means of a conventional solvent route, wherein the process comprises atmospheric distillation of a mixture of Light Arabic oil, with a high paraffin content and a high aromatic content, and up to 35% by mass of the Liza and Unity Gold oils, with a high naphthenic content and a low aromatic content;
wherein an atmospheric residue, with an initial boiling temperature of 370° C., is separated from the gases and fuels in the atmospheric distillation and sent to vacuum distillation;
wherein a vacuum residue with an initial boiling temperature of 550° C. is sent to a deasphalting step to obtain a deasphalted oil; and
and wherein the deasphalted oil is processed in the solvent route generating the microcrystalline paraffin.

2. The process according to claim 1, wherein the derivatives of Unity Gold and Liza oils have a low viscosity index compared to the Light Arabic oil.

3. The process according to claim 1, wherein the production of microcrystalline paraffin occurs without the use of a chemical reaction under high severity conditions that modifies product molecules.

4. The process according to claim 1, wherein the production of microcrystalline paraffin occurs without the use of an adsorption step of contaminants originating from the vacuum residue.

5. A microcrystalline paraffin obtained through the process as defined in claim 1, wherein the microcrystalline paraffin has a food grade with oil contents up to 2 by mass.
